(19) United States
(12) Patent Application Publication
(10) Pub. No.: US 2021/0288388 A1
(43) Pub. Date: Sep. 16, 2021

(54) RECHARGEABLE BATTERY

(71) Applicant: SAMSUNG SDI CO., LTD., Yongin-si, Gyeonggi-do (KR)

(72) Inventors: Sol CHOI, Yongin-si (KR); Hyeri EOM, Yongin-si (KR); Da-Un HAN, Yongin-si (KR); Juhyeong HAN, Yongin-si (KR)

(73) Assignee: Samsung SDI Co., Ltd., Yongin-si, Gyeonggi-do (KR)

(21) Appl. No.: 16/318,039

(22) PCT Filed: Jul. 5, 2017
(86) PCT No.: PCT/KR2017/007176

§ 371 Date: Jan. 15, 2019

(30) Foreign Application Priority Data
Jul. 27, 2016 (KR) 10-2016-0095748

(51) Int. Cl. H01M 50/533

(52) U.S. Cl. CPC H01M 50/533

(57) ABSTRACT

The present disclosure relates to a rechargeable battery including a first electrode including a first coating part and a first uncoated part disposed adjacent to the first coating part, a second electrode including a second coating part and a second uncoated part disposed adjacent to the second coating part, a separator interposed between the first electrode and the second electrode, a first electrode tab electrically connected to the first electrode; and a second electrode tab electrically connected to the second electrode, wherein at least one among the first uncoated part, the second uncoated part, the first electrode tab, and the second electrode tab includes a stress buffering part.

### TECHNICAL FIELD

The present disclosure relates to a rechargeable battery.

### BACKGROUND ART

In recent years, attention has been focused on development and commercial availability of flexible electronic devices such as flexible displays, wearable mobile phones, and watches. Therefore, there is a growing demand for realizing a flexible characteristic for a rechargeable battery, which is a power supply for such a flexible electronic device.

Generally, a rechargeable battery may be divided into a cylindrical battery, a prismatic battery, and a pouch-type battery depending on the shape. Among them, various attempts have been made to realize a flexible characteristic in the pouch-type battery in terms of high integration density, high energy density per weight, low cost, and easy deformation.

### DISCLOSURE

### Technical Problem

Exemplary embodiments provide a rechargeable battery with excellent durability under bending while having excellent flexibility.

### Technical Solution

The present disclosure provides a rechargeable battery including a first electrode including a first coating part and a first uncoated part disposed adjacent to the first coating part, a second electrode including a second coating part and a second uncoated part disposed adjacent to the second coating part, a separator interposed between the first electrode and the second electrode, a first electrode tab electrically connected to the first electrode, and a second electrode tab electrically connected to the second electrode, wherein at least one among the first uncoated part, the second uncoated part, the first electrode tab, and the second electrode tab includes a stress buffering part.

The present disclosure provides another rechargeable battery including a first electrode including a first coating part, a first uncoated part disposed at one side of the first coating part, and a third uncoated part disposed at the other side of the first coating part, a second electrode including a second coating part, a second uncoated part disposed at one side of the second coating part, and a fourth uncoated part disposed at the other side of the second coating part, a separator interposed between the first electrode and the second electrode, a first electrode tab electrically connected to the first electrode, and a second electrode tab electrically connected to the second electrode, wherein at least one among the first electrode tab, the second electrode tab, the first uncoated part, the third uncoated part, the second uncoated part, and the fourth uncoated part includes a stress buffering part.

### Advantageous Effects

According to exemplary embodiments, since the rechargeable battery of the present disclosure has an excellent bending characteristic, flexibility may be remarkably improved.

In addition, the rechargeable battery of the present disclosure has excellent stress dispersion characteristics even under repeated bending, and thus excellent durability may be secured.

### DESCRIPTION OF THE DRAWINGS

FIG. 1 is a perspective view of a rechargeable battery according to an exemplary embodiment of the present disclosure.

FIG. 2 is an exploded perspective view of the rechargeable battery according to FIG. 1.

FIG. 3 is a horizontal cross-sectional view showing an xy plane for an electrode assembly in the rechargeable battery according to FIG. 1.

FIG. 4 is a view showing an example of a shape of a stress buffering part.

FIG. 5 is a view showing a shape in which the rechargeable battery according to FIG. 1 is bent in a length direction.

FIG. 6 is a view showing an example of a shape of a stress buffering part.

FIG. 7 is a horizontal cross-sectional view showing an xy plane for an electrode assembly in a rechargeable battery according to another exemplary embodiment of the present disclosure.

FIG. 8 is an exploded perspective view of a rechargeable battery according to another exemplary embodiment of the present disclosure.

FIG. 9 is a horizontal cross-sectional view showing an xy plane for an electrode assembly in the rechargeable battery according to FIG. 8.

FIG. 10 and FIG. 11 are a horizontal cross-sectional view showing an xy plane for an electrode assembly in a rechargeable battery according to another exemplary embodiment of the present disclosure, respectively.

### MODE FOR INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

In addition, the size and thickness of each configuration shown in the drawings are arbitrarily shown for better understanding and ease of description, but the present invention is not limited thereto.

In addition, unless explicitly described to the contrary, the word “comprise” and variations such as “comprises” or “comprising” will be understood to imply the inclusion of stated elements but not the exclusion of any other elements.

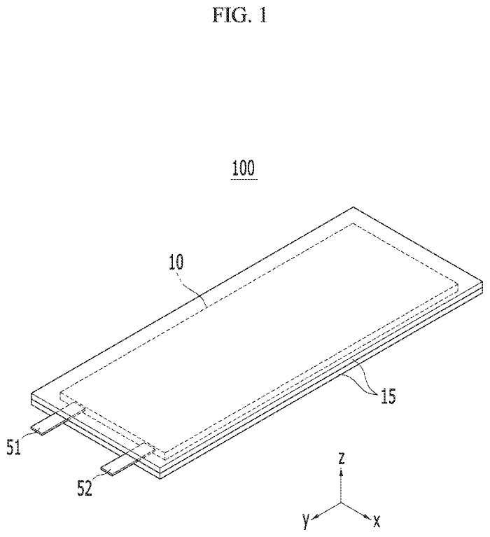

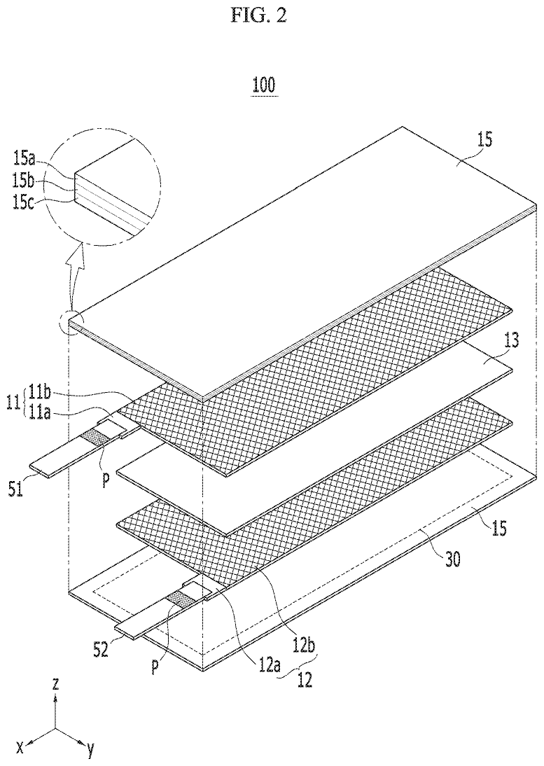

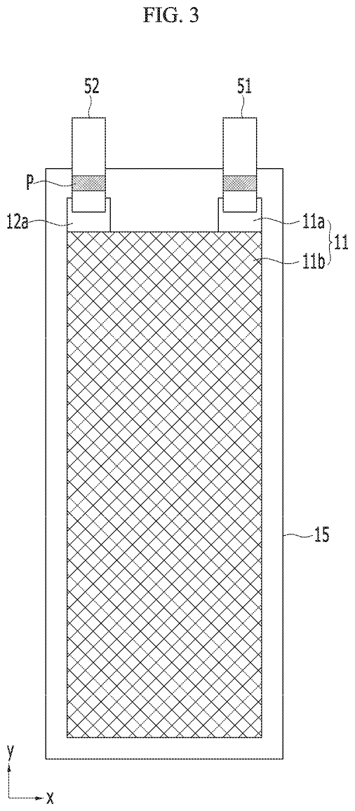

FIG. 1 is a perspective view of a rechargeable battery according to an exemplary embodiment of the present disclosure, FIG. 2 is an exploded perspective view of the rechargeable battery according to FIG. 1, and FIG. 3 is a horizontal cross-sectional view showing an xy plane for an electrode assembly in the rechargeable battery according to FIG. 1.

Referring to FIG. 1 to FIG. 3, a rechargeable battery 100 according to an exemplary embodiment of the present disclosure includes an electrode assembly 10 for charging and discharging a current, and an exterior member 15 having a flexible structure for receiving the electrode assembly 10.

The electrode assembly 10 includes a first electrode 11, a second electrode 12, and a separator 13 interposed between the first electrode 11 and the second electrode 12.

The electrode assembly 10, for example, is configured with a stacked structure by sequentially stacking and disposing the first electrode 11 and the second electrode 12 of a rectangular sheet shape with the separator 13 interposed therebetween.

FIG. 1 to FIG. 3 only show one first electrode 11 and one second electrode 12 for convenience, however a plurality of first electrodes 11 and second electrodes 12 may be stacked via separators 13 interposed therebetween to configure the electrode assembly 10.

Also, in the present disclosure, polarities of the first electrode 11 and the second electrode 12 are not particularly limited. That is, the first electrode 11 may be a positive electrode and the second electrode 12 may be a negative electrode, or the first electrode 11 may be the negative electrode and the second electrode 12 may be the positive electrode. Hereinafter, an example in which the first electrode 11 is the positive electrode and the second electrode 12 is the negative electrode is described for convenience.

The first electrode 11 includes a positive electrode current collector made of a metal thin plate having electrical conductivity, and a first coating part 11b in which a positive active material is coated on at least one surface of the positive electrode current collector. In this case, the positive active material is not entirely coated on at least one surface of the positive electrode current collector. Accordingly, the first electrode 11 includes the first coating part 11b to which the positive active material is coated and a first uncoated part 11a adjacent to the first coating part 11b and which is a region where the positive active material is not coated, that is, where the positive electrode current collector is exposed.

The positive electrode current collector may exemplarily have a form of a mesh or a form of a metal foil. As the positive electrode current collector, for example, aluminum or an aluminum alloy may be used.

The first coating part 11b may be made of, for example, cobalt, manganese, nickel, or a lithium transition metal oxide such as lithium cobalt oxide, lithium nickel oxide, lithium nickel cobalt oxide, lithium nickel cobalt aluminum oxide, lithium nickel cobalt manganese oxide, lithium manganese oxide, and lithium phosphate oxide, or may be made of composite oxides including at least of a metal selected from nickel sulfide, copper sulfide, sulfur, iron oxide, vanadium oxide, and combinations thereof, and lithium, but is not limited thereto.

A first electrode tab 51 may be connected to the first uncoated part 11a to be electrically connected to the first electrode 11. The first electrode tab 51 may be made of the same material as the positive electrode current collector.

The second electrode 12 includes a negative electrode current collector made of the metal thin plate having electrical conductivity, and a second coating part 12b on which the negative active material is coated on at least one surface of the negative electrode current collector. In this case, the negative active material is not entirely coated on at least one surface of the negative electrode current collector. Accordingly, the second electrode 12 includes the second coating part 12b on which the negative active material is coated and a second uncoated part 12a adjacent to the second coating part 12b and which is a region where the negative active material is not coated, that is, where the negative electrode current collector is exposed.

The negative electrode current collector may exemplarily have a form of a mesh or may a form of a metal foil. As the negative electrode current collector, for example, copper or copper alloy may be used.

The second coating part 12b may be made by using materials including at least one among a carbon material such as crystalline carbon, amorphous carbon, a carbon composite, carbon fiber, etc., a lithium metal, a metal oxide, and lithium alloys, but is not limited thereto.

A second electrode tab 52 may be connected to the second uncoated part 12a to be electrically connected to the second electrode 12. The second electrode tab 52 may be made of the same material as the negative electrode current collector.

In the stacked state, the first uncoated part 11a and the second uncoated part 12a may be alternatively arranged on both sides of the width direction (the x-axis direction) of the first electrode 11 and the second electrode 12. That is, as shown in FIG. 3, the first uncoated part 11a of the first electrode 11 is disposed on the right side and the second uncoated part 12a of the second electrode 12 is disposed on the left side at a predetermined distance from the first uncoated part 11a.

Therefore, the first electrode tab 51 and the second electrode tab 52, which are connected to the first uncoated part 11a and the second uncoated part 12a, respectively, are alternately arranged on both sides of the width direction (the x-axis direction) to have a predetermined interval therebetween. The first electrode tab 51 and the second electrode tab 52 are formed to draw out from one end of the exterior member 15 to the outside. The first electrode tab 51 and the second electrode tab 52 may be respectively connected to the first uncoated part 11a and the second uncoated part 12a, for example, by welding.

The separator 13 separates the first electrode 11 and the second electrode 12 and provides a passage for lithium ions, which is commonly used in rechargeable batteries. That is, a separator having excellent electrolyte solution wetting performance with low resistance for ion movement in the electrolyte can be used.

The separator 13 may be, for example, any one selected from a glass fiber, polyester, Teflon, polyethylene, polypropylene, polytetrafluoroethylene (PTFE), and combinations thereof, and may also be a non-woven fabric or a woven fabric type. Further, a separator coated with a ceramic component or a polymer material in order to secure mechanical strength or heat resistance may be used, optionally in a single-layer or multi-layer structure.

The electrode assembly 10 is received in a pair of exterior members 15 disposed at the top and bottom of the electrode assembly 10.

Referring to FIG. 2, each exterior member 15 includes an outer resin layer 15a, a moisture-permeation prevention layer 15b, and an inner resin layer 15c laminated sequentially from the outside.

The outer resin layer 15a acts as a protective layer, and is disposed outermost of the rechargeable battery 100.

The outer resin layer 15a may be configured of at least one selected from a group consisting of, for example, polyethylene terephthalate, polybutylene terephthalate, polyethylene naphthalate, polybutylene naphthalate, a polyester copolymer, polycarbonate, and nylon film, but is not limited thereto.

The thickness of the outer resin layer 15a may be, for example, 10 μm to 100 μm, and more specifically in a 10 μm to 50 μm range. When the thickness of the outer resin layer 15a is greater than 10 μm, it is not easily damaged due to its excellent physical characteristics. When the thickness is less than 100 μm, moldability characteristics such as injection and foaming are excellent. When being applied to the rechargeable battery 100, excellent electrical capacity may be ensured per unit volume.

The moisture-permeation prevention layer 15b is disposed on one side of the outer resin layer 15a where the electrode assembly 10 is disposed. The moisture-permeation prevention layer 15b is an intermediate layer serving as a barrier layer that may prevent leakage of an electrolyte solution or penetration of moisture and the like. The moisture-permeation prevention layer 15b may be formed as a thin plate-shaped member.

The moisture-permeation prevention layer 15b may, for example, be composed of aluminum or an aluminum alloy.

The thickness of the moisture-permeation prevention layer 15b, for example, may be 10 μm to 100 μm, and in detail, in a 10 μm to 50 μm or 10 μm to 30 μm range. When the thickness of the moisture-permeation prevention layer 15b satisfies the range, it is possible to effectively prevent leakage of the electrolyte solution and penetration of moisture from the outside and have excellent processability.

The inner resin layer 15c is disposed on one surface of the moisture-permeation prevention layer 15b, and is disposed on the opposite surface to the surface where the outer resin layer 15a is disposed. In addition, the inner resin layer 15c may have an insulation and heat fusion function.

The inner resin layer 15c may be formed of, for example, a copolymer of a polyolefin, or of a polyolefin, and more specifically, the polyolefin may be composed of polyethylene (PE) or polypropylene (PP), but is not limited thereto.

The thickness of the inner resin layer 15c may be 10 μm to 100 μm, in detail, in a 20 μm to 50 μm range. When the maximum thickness of the inner resin layer 15c satisfies the numerical range, it has excellent formability, adhesiveness, and chemical resistance.

The pair of exterior members 15 may be sealed by interposing a gasket at the edge after disposing the electrode assembly 10, or may be sealed by mutually fusing the inner resin layer 10 without providing a separate gasket.

On the other hand, in the present disclosure, at least one among the first uncoated part 11a, the second uncoated part 12a, the first electrode tab 51, and the second electrode tab 52 may include a stress buffering part P.

Referring to FIG. 3, in the present exemplary embodiment, the stress buffering part P may be disposed at the first electrode tab 51 and the second electrode tab 52. FIG. 3 shows a case that the stress buffering part P is disposed at all of the first electrode tab 51 and the second electrode tab 52, however the stress buffering part P may be disposed only at one of the first electrode tab 51 and the second electrode tab 52. However, in terms of flexibility, it is preferable that the stress buffering part P be disposed at both the first electrode tab 51 and the second electrode tab 52.

The stress buffering part P may include a plurality of patterns having at least one shape of, for example, a triangle, a quadrangle, a polygon, an ellipse, a circle, and combinations thereof.

At this time, each of a plurality of patterns may be formed to penetrate the stress buffering part P in the thickness direction.

Thus, since each of the plurality of patterns is formed through the stress buffering part P, the rechargeable battery 100 can be easily stretched when the battery 100 is bent, thereby more improving the flexibility of the rechargeable battery 100.

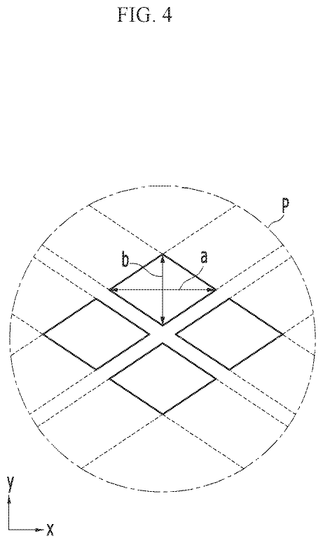

FIG. 4 shows an example of the shape of the stress buffering part P included in the rechargeable battery of the present disclosure.

Referring to FIG. 4, each of the plurality of patterns included in the stress buffering part P may have a first center axis a and a second center axis b. The second center axis b is disposed in the direction (the y axis direction) perpendicular to the first center axis a.

At this time, the length of the first center axis a may be formed longer than the length of the second center axis b. If the length of the first center axis a is longer than the length of the second center axis b, the stress dispersion may be more effectively performed when the rechargeable battery 100 is bent. Thus, the flexibility of the rechargeable battery 100 may be further improved, and the rechargeable battery 100 may be prevented from being damaged even with repeated bending, which is advantageous in improving flexibility and durability.

Also, the first center axis a may be disposed in the direction perpendicular to the direction in which the rechargeable battery 100 is bent.

The rechargeable battery 100 of the present disclosure may be bent in one direction. Here, the one direction may be any direction on the horizontal cross-sectional view of the rechargeable battery 100 of FIG. 3 and it is not limited to a specific direction. For example, the rechargeable battery 100 may have a rectangular shape in a plan view, and in this case, the bending direction of the rechargeable battery 100 may be a direction parallel to the long side or short side of the rechargeable battery 100. That is, referring to FIG. 3, the rechargeable battery 100 of the present disclosure may be bent in the long side direction (the y-axis direction) or may be bent in the short side direction (the x-axis direction) in a plan view.

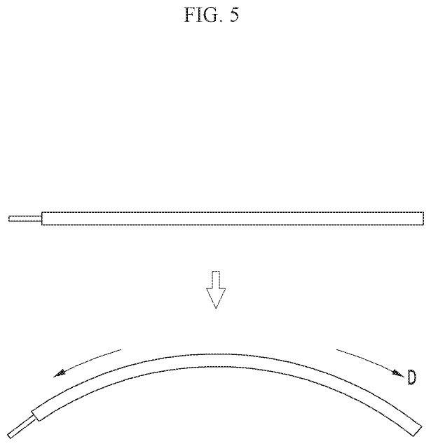

FIG. 5 shows a schematic representation in which the rechargeable battery of the present disclosure is bent in the long-side direction.

For example, when the rechargeable battery 100 of the present disclosure, as shown in FIG. 5, is bent in the long side direction, the first center axis a may be disposed in the short side direction in the plurality of patterns included in the stress buffering part P.

Accordingly, although not shown, when the rechargeable battery 100 is bent in the short side direction, the first center axis a may be disposed in the long side direction in the plurality of patterns included in the stress buffering part P.

As above-described, when the first center axis a having the relatively long length is disposed in the direction perpendicular to the bending direction of the rechargeable battery 100, the stress dispersion effect may be improved, thereby improving the flexibility and durability of the rechargeable battery 100.

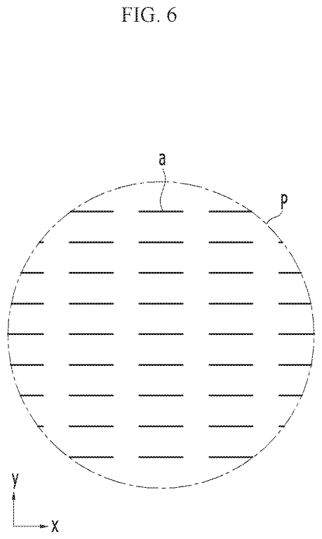

FIG. 6 shows an example of another shape of the stress buffering part P included in the rechargeable battery of the present disclosure.

Referring to FIG. 6, each of the plurality of patterns included in the stress buffering part P may be formed in a shape having only the first center axis a. That is, the shape of the pattern in the present disclosure includes the case where the length of the second center axis b is zero.

Thus, each of a plurality of patterns may be formed in such a shape that a straight line having a predetermined length penetrates the stress buffering part P in the thickness direction.

In this case, the flexibility and durability of the rechargeable battery 100 can be sufficiently secured as is realized in the present disclosure.

Next, the rechargeable battery according to another exemplary embodiment is described.

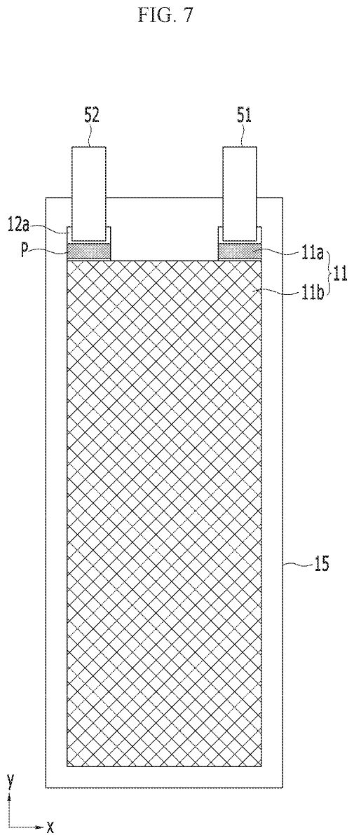

FIG. 7 is a horizontal cross-sectional view showing an xy plane for an electrode assembly in a rechargeable battery according to another exemplary embodiment of the present disclosure.

Referring to FIG. 7, in the present exemplary embodiment, a stress buffering part P may be disposed at the first uncoated part 11a and the second uncoated part 12a. FIG. 7 shows the case where the stress buffering part P is disposed in both the first uncoated part 11a and the second uncoated part 12a. However, the stress buffering part P may be located in only one of the first uncoated part 11a and the second uncoated part 12a. However, in terms of improving the flexibility of the rechargeable battery 100, it is preferable that the stress buffering part P is disposed in both the first uncoated part 11a and the second uncoated part 12a.

The rechargeable battery according to the present exemplary embodiment is the same as the rechargeable battery 100 according to an exemplary embodiment with reference to FIG. 1 to FIG. 3 except for the position of the stress buffering part P, and accordingly the detailed description for other configurations except for the position of the stress buffering part P is omitted.

Next, the rechargeable battery according to another exemplary embodiment of the present disclosure is described.

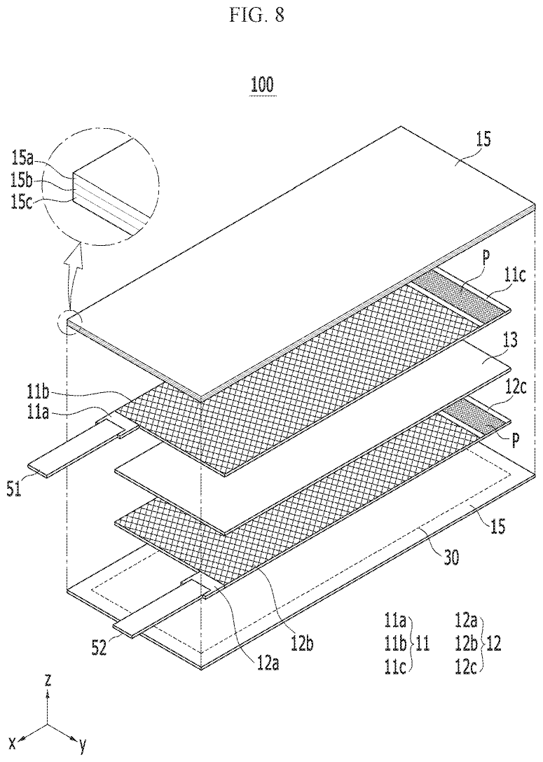

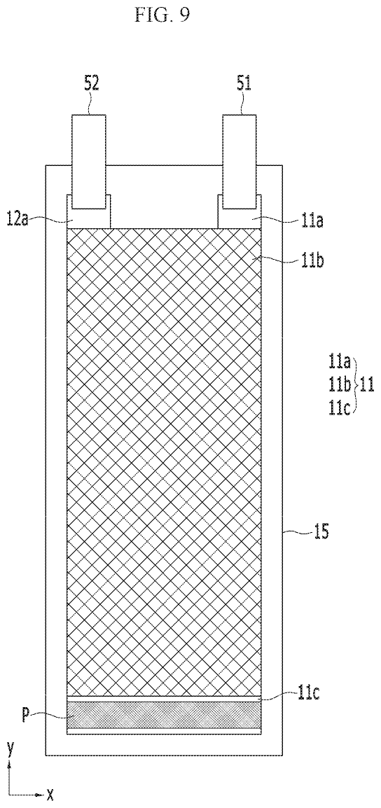

FIG. 8 is an exploded perspective view of a rechargeable battery according to another exemplary embodiment of the present disclosure, and FIG. 9 is a horizontal cross-sectional view showing an xy plane for an electrode assembly in the rechargeable battery according to FIG. 8.

Referring to FIG. 8 and FIG. 9, in the rechargeable battery according to the present exemplary embodiment, the electrode assembly 10 includes the first electrode 11, the second electrode 12, and the separator 13 interposed between the first electrode 11 and the second electrode 12.

In this case, the first electrode 11 includes the first coating part 11b, the first uncoated part 11a, and a third uncoated part 11c.

The first uncoated part 11a is disposed at one side of the first coating part 11b, and the third uncoated part 11c is disposed at the other side of the first coating part 11b, that is, the opposite side to the side where the first uncoated part 11a is disposed.

Also, the second electrode 12 includes the second coating part 12b, the second uncoated part 12a, and a fourth uncoated part 12c.

The second uncoated part 12a is disposed at one side of the second coating part 12b, and the fourth uncoated part 12c is disposed at the other side of the second coating part 12b, that is, the opposite side to the side where the second uncoated part 12a is disposed.

In the present exemplary embodiment, the stress buffering part P may be disposed at the third uncoated part 11c and the fourth uncoated part 12c. FIG. 8 shows the case that the stress buffering part P is disposed in both of the third uncoated part 11c and the fourth uncoated part 12c, however the stress buffering part P may be disposed in only one of the third uncoated part 11c and the fourth uncoated part 12c of course. However, in terms of flexibility improvement, it is preferable that the stress buffering part P is disposed in both the third uncoated part 11c and the fourth uncoated part 12c.

The rechargeable battery according to the present exemplary embodiment is the same as the rechargeable battery 100 according to an exemplary embodiment with reference to FIG. 1 to FIG. 3, except for the case that the third uncoated part 11c and the fourth uncoated part 12c are respectively included in the first electrode 11 and the second electrode 12 and the position of the stress buffering part P is different. Therefore, the detailed description of the other components except the position of the second uncoated part 12a, the fourth uncoated part, and the stress buffering part P is omitted.

Next, the rechargeable battery according to another exemplary embodiment is described.

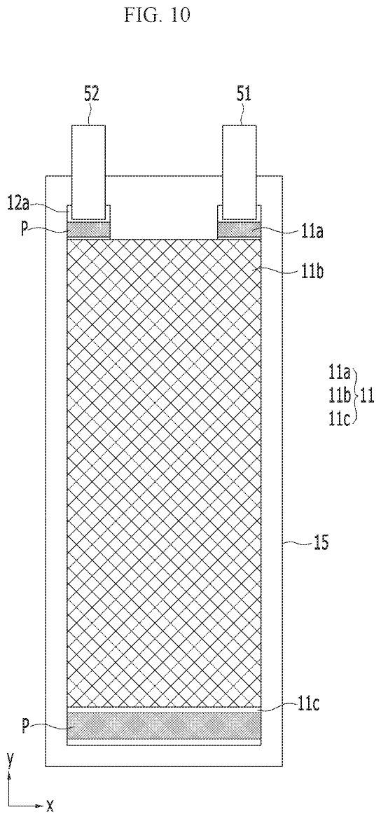

FIG. 10 is a horizontal cross-sectional view showing an xy plane for an electrode assembly in a rechargeable battery according to another exemplary embodiment of the present disclosure.

Referring to FIG. 10, in the present exemplary embodiment, a stress buffering part P is disposed in the first uncoated part 11a, the second uncoated part 12a, the third uncoated part 11c, and the fourth uncoated part (not shown). FIG. 10 shows the case that the stress buffering part P is disposed in all of the first uncoated part 11a, the second uncoated part 12a, the third uncoated part 11c, and the fourth uncoated part, however the stress buffering part P may be disposed in only part among the first uncoated part 11a, the second uncoated part 12a, the third uncoated part 11c, and the fourth uncoated part. However, in terms of improving the flexibility of the rechargeable battery, it is preferable that the stress buffering part P is disposed in all of the first uncoated part 11a, the second uncoated part 12a, the third uncoated part 11c, and the fourth uncoated part.

The rechargeable battery according to the present exemplary embodiment is the same as the rechargeable battery according to another exemplary embodiment with reference to FIG. 8 and FIG. 9 except for the position of the stress buffering part P, such that the detailed description of the other components except the position of the stress buffering part P is omitted.

Next, the rechargeable battery according to another exemplary embodiment is described.

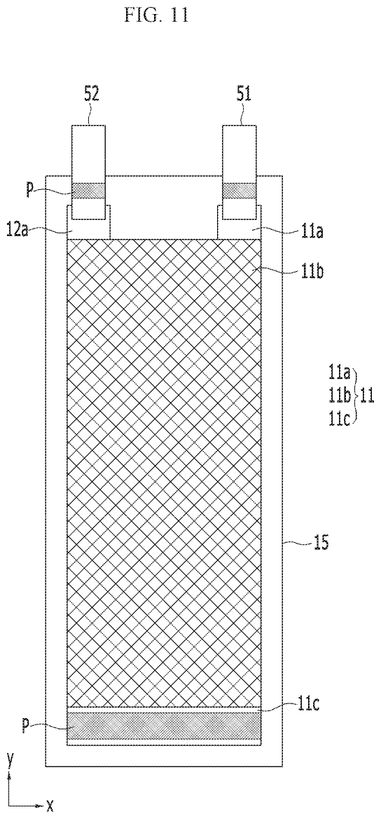

FIG. 11 is a horizontal cross-sectional view showing an xy plane for an electrode assembly in a rechargeable battery according to another exemplary embodiment of the present disclosure.

Referring to FIG. 11, in the present exemplary embodiment, a stress buffering part P may be disposed in the third uncoated part 11c, the fourth uncoated part (not shown), the first electrode tab 51, and the second electrode tab 52. FIG. 11 shows the case where the stress buffering part P is disposed in all of the third uncoated part 11c, the fourth uncoated part, the first electrode tab 51, and the second electrode tab 52, but the stress buffering part P may be disposed in part of the third uncoated part 11c, the fourth uncoated part (not shown), the first electrode tab 51, and the second electrode tab 52. However, in order to improve the flexibility of the rechargeable battery, it is preferable that the stress buffering part P is disposed in all of the third uncoated part 11c, the fourth uncoated part, the first electrode tab 51, and the second electrode tab 52.

The rechargeable battery according to the present exemplary embodiment is the same as the rechargeable battery according to another exemplary embodiment of FIG. 8 and FIG. 9 except for the position of the stress buffering part P, such that the detailed description of the other components except the position of the stress buffering part P is omitted.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

100: rechargeable battery
11: first electrode
12: second electrode
13: separator
51: first electrode tab
52: second electrode tab
15: exterior member
P: stress buffering part

1. A rechargeable battery comprising:
a first electrode including a first coating part and a first uncoated part disposed adjacent to the first coating part;
a second electrode including a second coating part and a second uncoated part disposed adjacent to the second coating part;
a separator interposed between the first electrode and the second electrode;
a first electrode tab electrically connected to the first electrode; and
a second electrode tab electrically connected to the second electrode,
wherein at least one among the first uncoated part, the second uncoated part, the first electrode tab, and the second electrode tab includes a stress buffering part.

2. The rechargeable battery of claim 1, wherein
the stress buffering part has a plurality of patterns having at least one shape among a triangle, a quadrangle, a polygon, an ellipse, a circle, and a mixture thereof.

3. The rechargeable battery of claim 2, wherein
Each of the plurality of patterns has a first center axis and a second center axis perpendicular to the first center axis.

4. The rechargeable battery of claim 3, wherein
the first center axis has a length that is longer than the length of the second center axis.

5. The rechargeable battery of claim 4, wherein
the first center axis is disposed in a direction perpendicular to a direction in which the rechargeable battery is bent.

6. The rechargeable battery of claim 3, wherein
the length of the second center axis is 0.

7. A rechargeable battery comprising:
a first electrode including a first coating part, a first uncoated part disposed at one side of the first coating part, and a third uncoated part disposed at the other side of the first coating part;
a second electrode including a second coating part, a second uncoated part disposed at one side of the second coating part, and a fourth uncoated part disposed at the other side of the second coating part;
a separator interposed between the first electrode and the second electrode;
a first electrode tab electrically connected to the first electrode; and
a second electrode tab electrically connected to the second electrode,
wherein at least one among the first electrode tab, the second electrode tab, the first uncoated part, the third uncoated part, the second uncoated part, and the fourth uncoated part includes a stress buffering part.

8. The rechargeable battery of claim 7, wherein
the stress buffering part has a plurality of patterns having at least one shape among a triangle, a quadrangle, a polygon, an ellipse, a circle, and a mixture thereof.

9. The rechargeable battery of claim 8, wherein
each of the plurality of patterns has a first center axis and a second center axis perpendicular to the first center axis.

10. The rechargeable battery of claim 9, wherein
the first center axis has a length that is longer than the length of the second center axis.

11. The rechargeable battery of claim 10, wherein
the first center axis is disposed in the direction perpendicular to the direction in which the rechargeable battery is bent.

12. The rechargeable battery of claim 9, wherein
the length of the second center axis is 0.

13. The rechargeable battery of claim 7, wherein
the first electrode tab is connected to the first uncoated part.

14. The rechargeable battery of claim 7, wherein
the second electrode tab is connected to the second uncoated part.
